(19) United States
(12) Patent Application Publication
(10) Pub. No.: US 2012/0176325 A1
(43) Pub. Date: Jul. 12, 2012

(54) Liquid Crystal Display Device

(76) Inventors: Kengo Okazaki, Mobara (JP); Kozo Arisato, Ichihara (JP); Yasuaki Kondo, Mobara (JP)

(21) Appl. No.: 13/335,511

(22) Filed: Dec. 22, 2011

(30) Foreign Application Priority Data
Jan. 12, 2011 (JP) 2011-004201

(51) Int. Cl. G09G 3/36; G06F 3/041

(52) U.S. Cl. 345/173; 345/92

(57) ABSTRACT

A liquid crystal display device includes a touch panel constructed from a single substrate plate and disposed over a liquid crystal display panel. A color filter is disposed over a TFT substrate, and the touch panel is bonded onto the color filter substrate by way of a first adhesion layer. An upper polarizing plate is bonded over the touch panel, and a front window is bonded over the upper polarizing plate via a second adhesion layer. The front window covers a terminal portion which is a portion where only the TFT substrate exists so as to physically protect the portion. Since the upper polarizing plate is disposed over the touch panel, the connection portion of the flexible wiring substrate for the touch panel does not contact with the front window. Thus, the touch panel can be prevented from being strained.

### CLAIM OF PRIORITY

The present application claims priority from Japanese Patent Application JP 2011-004201 filed on Jan. 12, 2011, the content of which is hereby incorporated by reference into this application.

### BACKGROUND OF THE INVENTION

1. Field of the Invention

The present invention relates to a liquid crystal display device, and particularly relates to a small display device including a touch panel used for cellular phones, etc.

2. Description of the Related Art

A liquid crystal display device includes a TFT substrate, a color filter opposing the TFT substrate, and liquid crystals put between the TFT substrate and the color substrate. The TFT substrate has pixels including pixel electrodes, thin film transistors (TFT), etc. formed thereon in a matrix form. The color filter substrate has color filters, etc. formed at positions corresponding to the pixel electrodes of the TFT substrate. The liquid crystal display device forms images by controlling light transmittance of each pixel using liquid crystal molecules.

Since liquid crystal display devices are available in a manner in which their size and thickness are reduced, they are used in various appliances such as cellular phones. Various functions have been added to the cellular phones in recent years. The input devices are required to have a touch panel function which enables a user to operate with his or her finger in addition to the existent key button operation. For devices having a touch panel function, the touch panel is attached to the color filter side of the liquid crystal display panel.

Liquid crystals do not emit light by themselves and thus a backlight is employed. Further, liquid crystals can control only polarized light. For image forming, therefore, light emitted from the backlight is polarized through a lower polarizing plate bonded beneath the TFT substrate, and the polarized light is controlled by the liquid crystals and then detected by the upper polarizing plate disposed over the color filter substrate.

JP-A-2003-36143 discloses a device employing a touch panel that comprises a pair of an upper substrate and a lower substrate and an upper polarizing plate disposed over the touch panel for visibility improvement. In addition, a hard coated film with a thickness of about 125 μm is bonded to the upper polarizing plate.

### SUMMARY OF THE INVENTION

Liquid crystal devices are demanded to be reduced in the outer size of the set as well as in the thickness while maintaining the size of the screen at a particular size. For the sake of reducing thickness, the outside part of the liquid crystal display panel is polished and thinned after being manufactured.

When the thickness of the liquid crystal display panel is to be reduced, a problem in physical strength will arise. If a physical pressure is exerted upon a display surface of a liquid crystal display panel, then the liquid crystal display panel may be damaged. In a liquid crystal display panel, the so-called terminal portion, which is a portion where the TFT substrate does not overlap with the color filter substrate, has a particularly low physical strength.

In the configuration described in JP-A-2003-36143, an about 0.1 mm thick film is bonded on the upper polarizing plate disposed over the touch panel. However, this does not reinforce the terminal portion of the TFT substrate where the physical strength is particularly low. In spite of the need for protecting the portion where only the TFT substrate exists as a single plate, the device disclosed in JP-A-2003-36143 is not provided with such protection.

A terminal portion of a touch panel needs to be connected with a flexible wiring substrate in order to supply power to the touch panel or take out signals therefrom. The device in JP-A-2003-36143 uses a pair of resistive film touch panels. This type does not have a problem in connecting the flexible wiring substrate.

On the other hand, touch panels having various uses employ a static capacitance type touch panel in which a touch panel substrate is configured from a single plate. In this type, the way of connecting the touch panel from its terminal with the flexible wiring substrate becomes a problem.

The present invention provides a liquid crystal display device equipped with a touch panel such that a terminal portion where a TFT substrate does not overlap with a color filter and that is constructed from a single plate is protected from the outside; and even when a touch panel of a single plate type is used, the device has no problem in connection of the flexible wiring substrate.

The present invention can overcome the problem described above and specifically provides the following configurations.

(1) A first aspect of the present invention is a liquid crystal display device comprising: a liquid crystal display panel including a liquid a TFT substrate and a color filter substrate with a crystal layer put between the substrates; and a touch panel; wherein the TFT substrate has a terminal portion formed thereon, the terminal portion being located where the TFT substrate does not overlap with the color filter substrate; the TFT substrate is bonded with a lower polarizing plate at the lower side of the TFT substrate; the touch panel is constructed from a single substrate; the touch panel is bonded directly to the color filter substrate by way of an adhesion layer; the touch panel is bonded with an upper polarizing plate; and the upper polarizing plate is bonded with a front window by way of an adhesion layer, the front window covering the terminal portion of the TFT substrate.

(2) A second aspect of the present invention is a liquid crystal display device according to the first aspect (1), wherein a flexible wiring substrate for the touch panel is connected to the touch panel, and the height of the flexible wiring substrate for the touch panel is smaller than the height of the upper polarizing plate.

A third aspect of the present invention is a liquid crystal display device according to the second aspect (2), wherein the flexible wiring substrate for the touch panel is connected to the touch panel by way of an anisotropic conductive film.

According to the present invention described above, even when the front window is made large to cover and protect the terminal portion of the liquid crystal display panel, and when the touch panel is constructed from a single plate, the PET film do not need to be provided to avoid the contact between the touch panel and the protrusion of the connection portion of the flexible wiring substrate. The process of forming the PET film can be omitted, thereby suppressing increase in the manufacturing cost of the liquid crystal display device.

Further, reflection at the boundary between the touch panel and the PET film can be prevented to improve image quality. Since the PET film is not used, polarizing effect that would otherwise be caused due to the PET film will not occur. Visibility of the liquid crystal display screen is not obstructed even when polarizing sunglasses are used. Further, since the PET film is not used, the thickness of the liquid crystal display device can be decreased by a portion corresponding to that of the PET film.

### BRIEF DESCRIPTION OF THE DRAWINGS

FIG. 1 is a cross sectional view of a liquid crystal display device according to the present invention;

FIG. 2 is a plan view of the liquid crystal display panel used in the invention;

FIG. 3 is a plan view of the liquid crystal display panel bonded with a touch panel and an upper polarizing plate;

FIG. 4 is a plan view in which a front window is bonded to the liquid crystal display panel and the touch panel;

FIG. 5 is a cross sectional view of the touch panel; and

FIG. 6 is a cross sectional view of a liquid crystal display device as a comparative example.

### DESCRIPTION OF THE PREFERRED EMBODIMENTS

Prior to the explanation of the present invention, the configuration for solving the above mentioned problems in the existent examples is described using a comparative example.

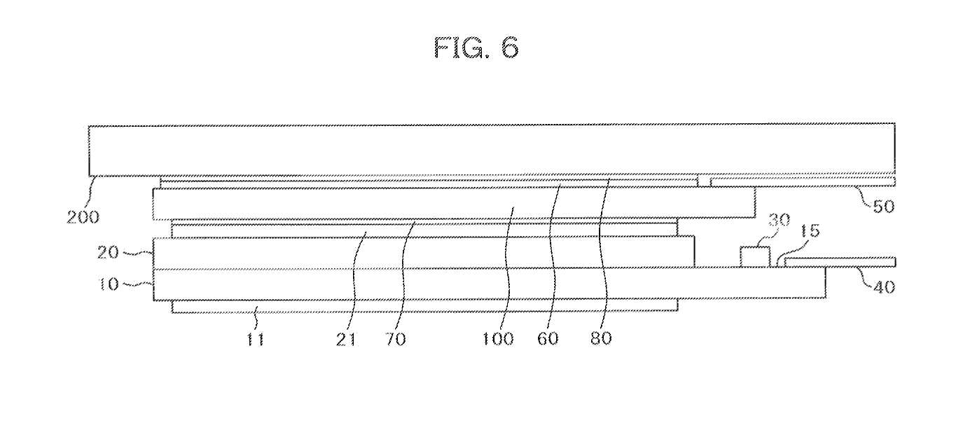

FIG. 6 is a cross sectional view showing a comparative embodiment. In FIG. 6, a color filter substrate 20 is disposed on a TFT substrate 10. Liquid crystals are put between the TFT substrate 10 and the color filter substrate 20. A driving IC 30 for driving the liquid crystals is disposed on a terminal portion 15, which is a portion where the TFT substrate 10 does not overlap with the color filter substrate 20. A flexible wiring substrate 40 is also attached to the terminal portion 15 in order to connect the liquid crystal display panel with an external circuit.

Since a flexible wiring substrate is also attached to a touch panel 100, a flexible wiring substrate connected to the liquid crystal display panel is referred to as a main flexible wiring substrate 40 while a flexible wiring substrate connected to a touch panel 100 is referred to as a flexible wiring substrate 50 for touch panel.

A lower polarizing plate 11 is bonded to the lower side of the TFT substrate 10, and an upper polarizing plate 21 is bonded upon the color filter substrate 20. The touch panel 100 is attached to the upper polarizing plate 21 by way of a first adhesion layer 70. The touch panel 100 has a single plate configuration. A PET film 60 is bonded over the touch panel 100. This is for the following reason.

FIG. 5 is a cross sectional view of a touch panel having a single plate configuration. The touch panel 100 shown in FIG. 5 is a static capacitance type touch panel 100. In FIG. 5, a lower wiring 102 is formed over the touch panel substrate 101, and an insulating layer 103 is formed over the lower wiring 102, an upper wiring 104 is formed over the insulating layer 103 and, further, a protective layer 105 is formed over the upper wiring 104. These films are formed by sputtering or the like and are thin films with a thickness of about 1 μm thickness in total.

On the other hand, a flexible wiring substrate 50 of the touch panel for supplying power to the touch panel 100 or taking out signals therefrom, and an anisotropic conductive film 106 for connecting flexible wiring substrate 50 and the touch panel 100 are thick and has a thickness of about 100 μm in total.

Upon attaching a front window 200 onto the touch panel 100, since the flexible wiring substrate 50 of the touch panel protrudes, a gap is formed between the touch panel 100 and the front window 200. This raises a problem for connecting the touch panel 100 and the front window 200. In order to solve this problem, a PET film 60 of about 0.1 mm thickness is used.

The front window 200 is bonded onto the PET film 60 via a second adhesion layer 80. Although the front window 200 here is formed of glass, it may be also formed of resin such as an acrylic resin. As shown in FIG. 6, the front window 200 is formed larger than the TFT substrate 10 of the liquid crystal display panel.

The front window 200 in FIG. 6 protects the portion that has the least physical strength in the liquid crystal display panel, where only the TFT substrate 10 exists as a single plate. However, when the flexible wiring substrate 50 is connected to the touch panel 100, a gap between the front window 200 and the touch panel 100 issues a problem and makes it essential to dispose the PET film 60.

The comparative example of FIG. 6 requires a step of bonding the PET film 60 in its manufacturing. Further, even for a thickness of about 0.1 mm, the thickness-reduction of the panel is hindered for the thickness of PET film 60. Since the PET film 60 is stretched in the production process, the PET film also causes a polarizing effect in this direction.

People such as fishermen use polarizing sunglasses at places such as sea shores to see inside the sea from land. When one uses a liquid crystal display device. including the PET film 60 with polarizing sunglasses on, the screen of the liquid crystal display device cannot be seen due to the polarizing effect of the PET film 60.

The present invention to be described using the following preferred embodiment addresses the problems in the existent and comparative examples, and is adapted to reduce the size and suppress the manufacturing cost while ensuring the physical strength.

### Embodiment 1

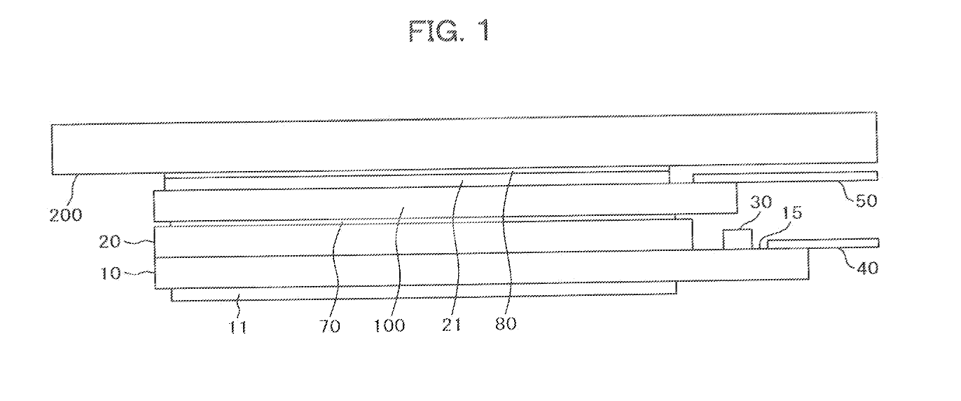

FIG. 1 is a cross sectional view of a liquid crystal display device according to the present invention. In FIG. 1, a color filter 20 is stacked on a TFT substrate 10. Liquid crystals (not illustrated) are put between the TFT substrate 10 and the color filter substrate 20. A lower polarizing plate 11 is bonded to the lower side of the TFT substrate 10. A backlight (not illustrated) is disposed below the lower polarizing plate 11. Light emitted from the backlight is polarized by the lower polarizing plate 11 and then enters the liquid crystal layer.

A driving IC 30 is disposed on a terminal portion 15 where the color filter 20 does not overlap with the TFT substrate 10. A main flexible wiring substrate 40 is also attached to the terminal portion 15 to connect the liquid crystal display panel with the outside.

The portion in which the TFT substrate 10 does not overlap with the color filter substrate 20 is constructed from a single plate of the TFT substrate 10 and its strength is weak. In a liquid crystal display panel that is polished for reducing thickness, the thickness of the TFT substrate 10 may be about 0.2 mm for example. In this embodiment, the terminal portion 15, that is, the portion comprised from only one plate of the TFT substrate 10 is protected by covering it with a front window 200.

In FIG. 1, instead of an upper polarizing plate 21, a touch panel 100 is attached onto the color filter substrate 20 via a first adhesion layer 70. The touch panel 100 is a static capacitance type and is constructed from a single plate as with the device shown in FIG. 5. An upper polarizing plate 21 is bonded onto the touch panel 100.

The bonding of the upper polarizing plate 21 is done in a manner similar to the bonding of the upper. polarizing plate 21 onto the color filter substrate 20 of the liquid crystal display panel. The front window 200 is attached onto the upper polarizing plate 21 via a second adhesion layer 80.

The front window 200 is formed to be larger than the TET substrate 10 in the liquid crystal display panel so as to cover and protect the terminal portion 15 where the TFT substrate 10 does not overlap with the color filter substrate 20 and that is weak in strength.

In this case, the structure of connecting the touch panel 100 with the flexible wiring substrate 50 for the touch panel is of a problem. Since the portion of the touch panel 100 connected with the flexible wiring substrate 50 protrudes upwards from the other portions, the attachment of the front window 200 onto the touch panel 100 is influenced.

The device according to the present invention solves this problem by disposing the polarizing plate on the touch panel 100. In FIG. 1, the thickness of the polarizing plate is about 0.13 mm. Accordingly, the flexible wiring substrate 50 for the touch panel does not contact with the front window 200 and no stress is caused between them.

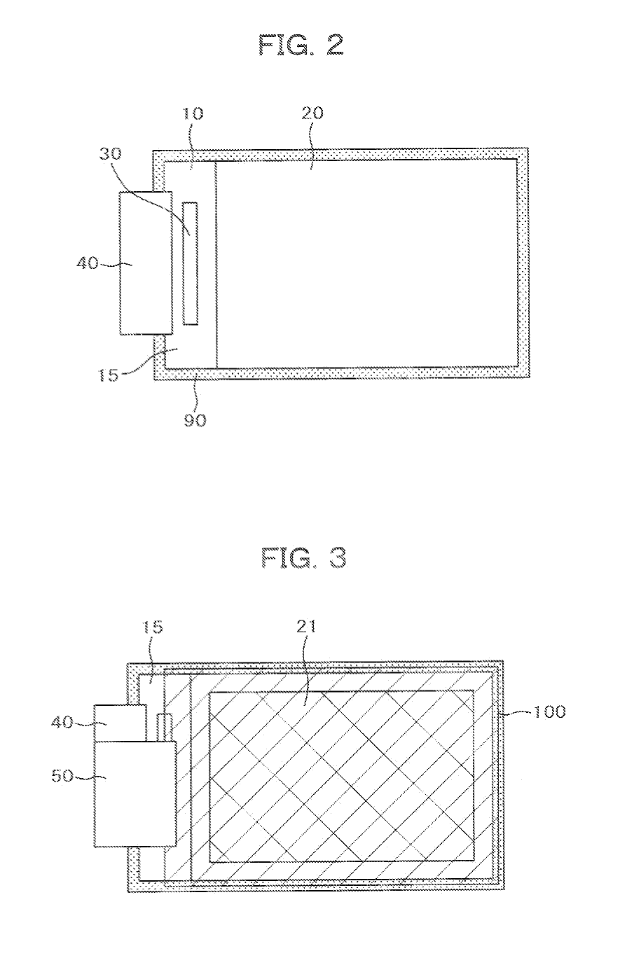

FIGS. 2 to 4 are plan views showing the steps of providing the configuration of the present invention. FIG. 2 is a plan view of a liquid crystal display panel. In FIG. 2, a liquid crystal display panel having the TFT substrate 10 stacked on the color filter substrate 20 is placed within a resin mold 90.

A driving IC 30 is disposed on a terminal portion 15 where the TFT substrate 10 and the color filter substrate 20 do not overlap. A main flexible wiring substrate 40 is also connected to the terminal portion 15 to supply electric signals to the liquid crystal display panel.

While an upper polarizing plate 21 is bonded onto the color filter substrate 20 in a common configuration, the upper polarizing plate 21 is not bonded to the color filter substrate 20 this invention. A lower polarizing plate 11 (not shown) is bonded at the back of the TFT substrate 10. Further, a backlight is contained in the resin mold 90 under the TFT substrate 10. In FIG. 2, a portion having the least strength is the terminal portion 15 where the TFT substrate 10 comprises a single plate.

FIG. 3 is a plan view of the liquid crystal display panel shown in FIG. 2 equipped with the touch panel 100. The touch panel 100 is bonded to the color filter substrate 20 in the liquid crystal display panel via the first adhesion layer 70 (not shown). The touch panel 100 is formed somewhat larger than the color filter substrate 20 so as to completely cover the display area of the liquid crystal display panel.

The touch panel 100 of this embodiment is to be made of glass. It may instead be a plastic substrate as long as it can withstand annealing of an ITO electrode. Examples of the plastic substrate are acrylic resin, polycarbonate resin, etc.

The first adhesion layer 70 for bonding the touch panel 100 to the color filter substrate 20 of the liquid crystal display panel may be an adhesive material (bonding adhesive) or a pressure sensitive adhesive material.

An example of a suitable adhesive material is a UV-curable resin which is initially a liquid. The liquid crystal display panel and the touch panel 100 are bonded in a reduced-pressure atmosphere to prevent intrusion of air bubbles.

An example of a suitable pressure sensitive adhesive material is an acrylic transparent pressure sensitive adhesive material. A thermoplastic resin is used both for the adhesive material and the pressure sensitive adhesive material. This is in order to enable the front window 200, the touch panel 100, and the liquid crystal display panel to be peeled for repairing for when failures such as air bubbles or contaminants are found after finishing production.

As shown in FIG. 3, the upper polarizing plate 21 is bonded onto the touch panel 100. The thickness of the upper polarizing plate is about 0.13 mm. A flexible wiring substrate 50 for supplying electric power to the touch panel 100 or taking out signals from the touch panel 100 is connected to the end of the touch panel 100.

As shown in FIG. 5, the flexible wiring substrate 50 is connected to the touch panel 100 via an anisotropic conductive film 106. The height of this connection portion is about 0.1 mm as a total of the anisotropic conductivity film 106 and the flexible wiring substrate 50 for touch panel. The height of the upper polarizing plate 21 is larger than the height of the connection portion of the flexible wiring substrate 50 for touch panel.

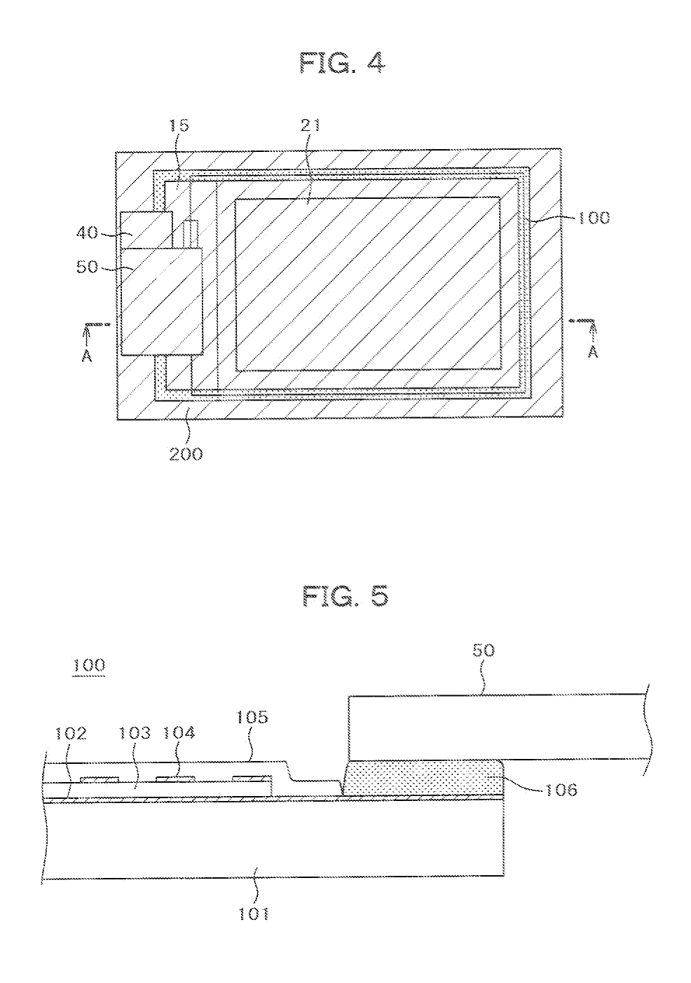

FIG. 4 is a plan view showing a state of the liquid crystal display panel where the front window 200 is attached to cover the touch panel 100 and the upper polarizing plate 21. The front window 200 is bonded to the upper polarizing plate 21 disposed over the touch panel 100 via a second adhesion layer 80 (not illustrated). The front window 200 is formed large in order to protect the liquid crystal display panel and other parts from the outside and covers the entire liquid crystal display panel including the resin mold 90.

The front window 200 is generally formed of glass and has a thickness of about 0.5 mm. Plastic materials such as acrylic or polycarbonate resin may also be used as a material of the front window 200. The second adhesion layer 80 for bonding the upper polarizing plate 21 and the front window 200 may be an adhesive material or a pressure sensitive adhesive material.

An example of a suitable adhesive material is a UV-curable resin. An example of a suitable pressure sensitive adhesive material is an acrylic resin. The method of bonding the upper polarizing plate 21 and the front window 200 is similar to the bonding of the color filter substrate 20 and the touch panel 100.

According to the present invention described above, even when the front window 200 is made large to cover and protect the terminal portion 15 of the liquid crystal display panel, and when the touch panel 100 is constructed from a single plate, the PET film 60 do not need to be provided to avoid the contact between the touch panel 100 and the protrusion of the connection portion of the flexible wiring substrate 50. The process of the PET film 60 can be omitted, thereby suppressing increase in the manufacturing cost of the liquid crystal display device.

Further, reflection at the boundary between the touch panel 100 and the PET film 60 can be prevented to improve image quality. Since the PET film 60 is not used, polarizing effect due to the PET film 60 will not be caused. Visibility of the liquid crystal display screen is not obstructed even when polarizing sunglasses are used. Further, since the PET film 60 is not used, the thickness of the liquid crystal display device can be decreased for the thickness of the PET film 60.

What is claimed is:

1. A liquid crystal display device comprising:
a liquid crystal display panel including a liquid a TFT substrate and a color filter substrate with a crystal layer put between the substrates; and
a touch panel;
wherein the TFT substrate has a terminal portion formed thereon, the terminal portion being located where the TFT substrate does not overlap with the color filter substrate;
the TFT substrate is bonded with a lower polarizing plate at the lower side of the TFT substrate;
the touch panel is constructed from a single substrate;
the touch panel is bonded directly to the color filter substrate by way of an adhesion layer;
the touch panel is bonded with an upper polarizing plate; and
the upper polarizing plate is bonded with a front window by way of an adhesion layer, the front window covering the terminal portion of the TFT substrate.

2. A liquid crystal display device according to claim 1, wherein a flexible wiring substrate for the touch panel is connected to the touch panel, and the height of the flexible wiring substrate for the touch panel is smaller than the height of the upper polarizing plate.

3. A liquid crystal display device according to claim 2, wherein the flexible wiring substrate for the touch panel is connected to the touch panel by way of an anisotropic conductive film.
